(19) United States
(12) Patent Application Publication
(10) Pub. No.: US 2019/0037043 A1
(43) Pub. Date: Jan. 31, 2019

(54) Data Prefetching Method and Apparatus

(71) Applicant: Huawei Technologies Co., Ltd., Shenzhen (CN)

(72) Inventors: Xiaoxin Xu, Hangzhou (CN); Ligang Chen, Shenzhen (CN); Yixiang Liao, Hangzhou (CN)

(21) Appl. No.: 16/133,179

(22) Filed: Sep. 17, 2018

Related U.S. Application Data
(63) Continuation of application No. PCT/CN2017/074388, filed on Feb. 22, 2017.

(30) Foreign Application Priority Data
Mar. 17, 2016 (CN) 201610153153.9

(51) Int. Cl. H04L 29/08; G06F 9/4401; G06F 9/455

(52) U.S. Cl. CPC H04L 67/2847; H04L 67/101; G06F 2009/45575; G06F 9/4416; G06F 9/45558; H04L 67/34

(57) ABSTRACT

A data prefetching method and a prefetching apparatus to improve system service performance, where the data prefetching method includes a first prefetching apparatus receives a data prefetching instruction from a first host. The first prefetching apparatus determines a target data block based on the data prefetching instruction, and obtains identification of a target prefetching apparatus from a second prefetching apparatus. Then the first prefetching apparatus determines a target storage location of the target data block based on the identification, and obtains the target data block based on the target storage location.

### CROSS-REFERENCE TO RELATED APPLICATIONS

This application is a continuation of International Patent Application No. PCT/CN2017/074388 filed on Feb. 22, 2017, which claims priority to Chinese Patent Application No. 201610153153.9 filed on Mar. 17, 2016. The disclosures of the aforementioned applications are hereby incorporated by reference in their entireties.

### TECHNICAL FIELD

The present disclosure relates to the field of data storage, and in particular, to a data prefetching method and apparatus.

### BACKGROUND

Rapid development of cloud computing is strongly supported by a virtualization technology. In the virtualization technology, a plurality of virtual machines (VMs) are usually deployed on a host, and resources of the host are allocated to each VM using a hypervisor such that each VM can independently perform a computing function.

When the VM on the host is being started, boot image data of the VM needs to be read from a storage apparatus connected to the host. When different VMs are started, some of boot image data read by the VMs is repeated. Therefore, in the traditional technology, when a VM cluster is being started, one VM is usually first started, and boot image data of the VM is written into a cache of a host. In this way, when another VM is being started, repeated boot image data may be directly obtained from a local cache, and only little non-repeated data needs to be read from a storage apparatus.

However, in actual application, there may be different types of VMs on one host, and there is a large difference between boot image data corresponding to the different types of VMs. Therefore, when there are a plurality of types of VMs on the host, boot image data stored in the cache has little same data as boot image data required by a to-be-started VM. To reduce data read from the storage apparatus as far as possible, the boot image data of the different types of VMs needs to be written to the cache of the host. Consequently, a host cache occupation rate is high, and a cache hit rate is low. Therefore, a host service process is slow, and performance cannot meet a usage requirement.

### SUMMARY

The present disclosure provides a data prefetching method to improve host service performance in a cluster system.

A first aspect of the present disclosure provides a data prefetching method, and method is applicable to a cluster system. The cluster system includes a plurality of prefetching apparatuses, and each prefetching apparatus is uniquely connected to one host, and is connected to one or more disks. All the prefetching apparatuses are also connected to each other. In the present disclosure, a first prefetching apparatus that is connected to a first host and a first disk is used as an example for description. Before the first host starts a VM, the first prefetching apparatus receives a data prefetching instruction from the first host, where the data prefetching instruction is used to indicate boot image data required by the first host to start the VM on the first host. The first prefetching apparatus determines one or more target data blocks based on the data prefetching instruction, where the target data block is part of the boot image data. If the first prefetching apparatus does not store the target data block, the first prefetching apparatus obtains identifier information of a target prefetching apparatus from a second prefetching apparatus. The second prefetching apparatus is a prefetching apparatus that is connected to a target storage apparatus that stores the target data block, and the target prefetching apparatus is a prefetching apparatus that is in the plurality of prefetching apparatuses in the cluster system and that stores the target data block. If an original storage location of the target data block is the target storage apparatus in the cluster system, when target prefetching apparatus obtains the target data block, the second prefetching apparatus connected to the target storage apparatus records identifier information of each target prefetching apparatus. Therefore, the first prefetching apparatus can obtain the identifier information of the target prefetching apparatus from the second prefetching apparatus. The first prefetching apparatus determines a target storage location of the target data block based on the identifier information of the target prefetching apparatus, and prefetches the target data block from the target storage location to the first prefetching apparatus. In this method, the boot image data originally stored in a cache of the host is stored in the prefetching apparatus outside the host, and when the VM on the host is being started, the boot image data is directly obtained from the prefetching apparatus. Compared with other approaches in which the boot image data is directly read from the storage apparatus, in this embodiment, repeated data needs to be written into the prefetching apparatus only once. This reduces data read and write times and bandwidth occupation. Compared with the other approaches in which the boot image data is stored in the cache of the host, in the method provided in the present disclosure, the boot image data does not occupy much of the cache of the host. Therefore, a host cache hit rate is not low, and a cache occupation rate is not high. This accelerates a host service process, and improves host service performance.

Optionally, the first prefetching apparatus may request address information of the target prefetching apparatus from the second prefetching apparatus, and receive an identifier information list returned by the second prefetching apparatus. The identifier information list may record identifier information of one or more target prefetching apparatuses. If the identifier information list returned by the second prefetching apparatus is empty, it indicates that no prefetching apparatus reads the target data block from a second storage apparatus, and the target data block is stored merely in the second storage apparatus. In this case, the first prefetching apparatus determines the second storage apparatus as the target storage location of the target data block.

Optionally, if the identifier information list returned by the second prefetching apparatus is not empty, it indicates that a target prefetching apparatus reads the target data block from the second storage apparatus. The target data block is stored not only in the second storage apparatus, but also in the target prefetching apparatus. In this case, the first prefetching apparatus may determine and obtain the target storage location of the target data block based on identifier information of the target prefetching apparatus that is recorded in the identifier information list. The first prefetching apparatus determines, based on identifier information of each target prefetching apparatus, a shortest delay in delays of accessing all the target prefetching apparatuses, and a target prefetching apparatus corresponding to the shortest delay. If the shortest delay is less than a delay of accessing the target storage apparatus by the first prefetching apparatus, the target prefetching apparatus corresponding to the shortest delay is determined as the target storage location of the target data block. If the shortest delay is greater than a delay of accessing the target storage apparatus by the first prefetching apparatus, the target storage apparatus is determined as the target storage location of the target data block. In this method, it can be ensured that a delay of obtaining the target data block from the target storage location is minimized.

Optionally, the first prefetching apparatus may perform aligned partitioning on the boot image data based on the data prefetching instruction to obtain one or more target data blocks.

Optionally, at an initial running stage of the cluster system, the first prefetching apparatus may register a virtual storage disk with a hypervisor on the first host to present a connected storage apparatus to the first host in a form of a virtual storage disk. The hypervisor on the first host delivers a data prefetching command in a form of a data set management (DSM) command to the virtual storage disk on the first host, and the first prefetching apparatus receives the data prefetching command.

Optionally, when the VM on the first host is being started, the first host delivers a data read instruction to the first prefetching apparatus to instruct to read the target data block. The first prefetching apparatus sends the locally stored target data block to the first host based on the data read instruction.

A second aspect of the present disclosure provides a prefetching apparatus, used as a first prefetching apparatus in a cluster system. The prefetching apparatus includes an instruction receiving module configured to, before a first host starts a VM, receive a data prefetching instruction from the first host, where the data prefetching instruction is used to indicate start data required by the first host to start the VM on the first host, a data determining module configured to determine one or more target data blocks based on the data prefetching instruction, an information obtaining module configured to obtain identifier information of a target prefetching apparatus from a second prefetching apparatus when the first prefetching apparatus does not store the target data block, where second prefetching apparatus is a prefetching apparatus connected to a target storage apparatus that stores the target data block, and the target prefetching apparatus is a prefetching apparatus that is in a plurality of prefetching apparatuses in the cluster system and that stores the target data block, a location determining module configured to determine a target storage location of the target data block based on identifier information of the target data block, and a data storage module configured to prefetch the target data block from the target storage location to the first prefetching apparatus.

Optionally, the information obtaining module is configured to request address information of the target prefetching apparatus from the second prefetching apparatus, and receive an identifier information list returned by the second prefetching apparatus. The identifier information list may record identifier information of one or more target prefetching apparatuses. The location determining module is configured to if the identifier information list of the target prefetching apparatus is empty, determine the target storage apparatus as the target storage location.

Optionally, the location determining module is further configured to, if the identifier information list returned by the second prefetching apparatus is not empty, determine and obtain the target storage location of the target data block based on the identifier information of the target prefetching apparatus that is recorded in the identifier information list. A shortest delay in delays of accessing all target prefetching apparatuses is determined based on identifier information of each target prefetching apparatus, and a target prefetching apparatus corresponding to the shortest delay is determined. If the shortest delay is less than a delay of accessing the target storage apparatus by the first prefetching apparatus, the target prefetching apparatus corresponding to the shortest delay is determined as the target storage location of the target data block. If the shortest delay is greater than a delay of accessing the target storage apparatus by the first prefetching apparatus, the target storage apparatus is determined as the target storage location of the target data block. In this method, it can be ensured that a delay of obtaining the target data block from the target storage location is minimized.

Optionally, the data determining module is configured to perform aligned partitioning on the boot image data based on the data prefetching instruction to obtain one or more target data blocks.

Optionally, the instruction receiving module is configured to at an initial running stage of the cluster system, register a virtual storage disk with a hypervisor on the first host to present a connected storage apparatus to the first host in a form of a virtual storage disk. The hypervisor on the first host delivers a data prefetching command in a form of a DSM command to the virtual storage disk on the first host, and the first prefetching apparatus receives the data prefetching command.

Optionally, when the VM on the first host is being started, the first host delivers a data read instruction to the first prefetching apparatus, to instruct to read the target data block. The instruction receiving module is further configured to receive the data read instruction. The prefetching apparatus may further include a data sending module configured to send the locally stored target data block to the first host based on the data read instruction.

A third aspect of the present disclosure provides a computing device, including a processor, a memory, a communications interface, and a bus. By invoking program code stored in the memory, the processor is configured to perform the data prefetching method provided in the first aspect of the present disclosure.

### BRIEF DESCRIPTION OF DRAWINGS

FIG. 1 is a schematic diagram of an architecture of a cluster system;

FIG. 2 is a schematic diagram of an architecture of a cluster system based on the present disclosure;

FIG. 3 is a structural diagram of an embodiment of a computing device based on the present disclosure;

FIG. 4 is a flowchart of an embodiment of a data prefetching method based on the present disclosure; and

FIG. 5 is a structural diagram of an embodiment of a prefetching apparatus based on the present disclosure.

### DESCRIPTION OF EMBODIMENTS

The present disclosure provides a data prefetching method to increase a cache hit rate when a host in a cluster system starts a VM. The present disclosure further provides a related prefetching apparatus. Separate descriptions are provided in the following.

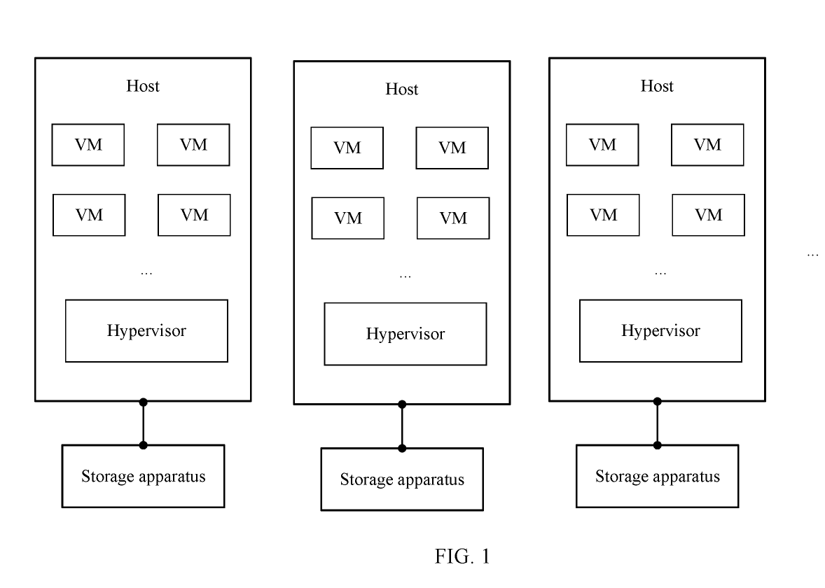

Rapid development of cloud computing is strongly supported by a virtualization technology. For a basic architecture of a cluster system in the virtualization technology, refer to FIG. 1. The cluster system includes a plurality of hosts, a plurality of VMs are deployed on each host, and a hypervisor is further deployed on each host to allocate resources of the host to each VM such that each VM can independently perform a computing function. Each host is connected southbound to a storage apparatus that is used for storing data. The storage apparatus may be a disk or a solid-state drive (SSD). When starting a VM, the host needs to read boot image data of the VM from the storage apparatus such that the VM can use the boot image data.

In the cluster system, usually a large quantity of VMs are deployed on each host.

When a large quantity of VMs are started in the cluster system, a massive quantity of data read and write operations are generated in a short time period. The massive quantity of data read and write operations occupy large network bandwidth, affecting a service, or even causing breakdown of the VM.

It is researched that, when different VMs are started, some of boot image data read by the VMs is repeated. Therefore, in the other approaches, when a VM cluster is being started, one VM is usually first started, and boot image data of the VM is written into a cache of a host. In this way, when another VM is being started, repeated boot image data may be directly obtained from a local cache of the host, and only little non-repeated data needs to be read from a storage apparatus. In this way, a large quantity of read and write operations on the storage apparatus can be reduced, system bandwidth and read and write resources are saved, and a VM start time is reduced.

However, in processing, there may be different types of VMs on one host, and there is a large difference between boot image data corresponding to the different types of VMs. For example, if a VM 1 has a WINDOWS operating system, and a VM 2 has a LINUX operating system, the VM 1 has little same boot image data as the VM 2. In this case, to still save system bandwidth and read and write resources, and reduce a VM start time, the host needs to store both a boot image data of the WINDOWS operating system and a boot image data of the LINUX operating system to a cache of the host. Therefore, when there are many types of VMs on the host, boot image data stored in the cache of the host significantly increases. A series of problems may be caused when an amount of the boot image data in the cache is increased. For example, a cache occupation rate of the host is extremely high, a cache hit rate is low, and a host service process is slow, severely affecting host performance.

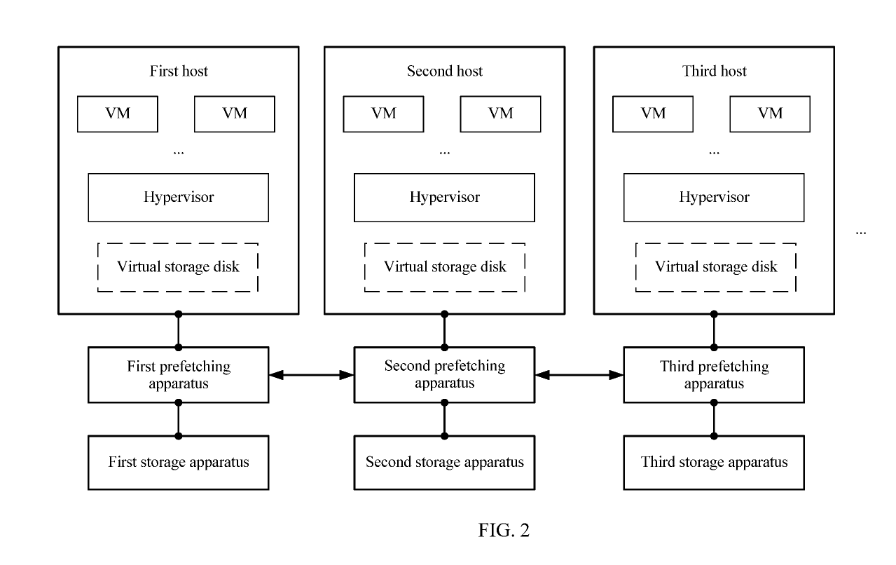

For the foregoing problems, this disclosure provides a data prefetching method based on the traditional technology to improve host performance. In this disclosure, a prefetching apparatus is added between a host and a storage apparatus, and a cluster system that is different from that in the traditional technology is obtained. An architecture of the cluster system is shown in FIG. 2. It can be seen from FIG. 2 that, each prefetching apparatus is connected northbound to the host, is connected southbound to the storage apparatus, and different prefetching apparatuses are connected eastbound and westbound to each other. The prefetching apparatus is configured to prefetch (that is, perform prefetching before a VM is started) boot image data to the prefetching apparatus, and send the stored boot image data to the host when the host starts the VM. In this way, the host does not need to store the boot image data to a local cache.

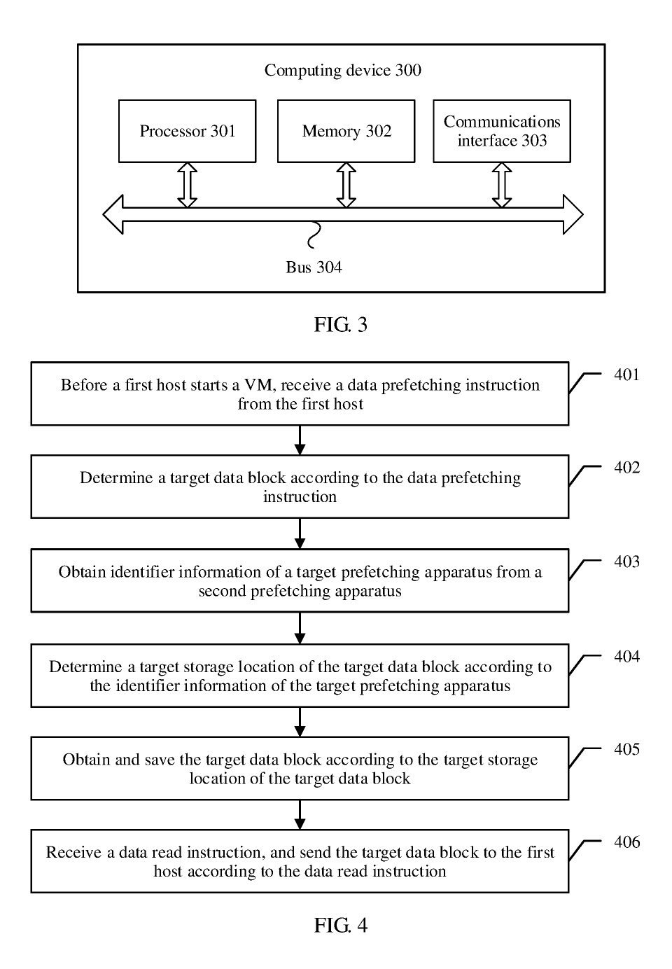

The prefetching apparatus in FIG. 2 may be implemented by a computing device 300 in FIG. 3. For an organization structure of the computing device 300, refer to FIG. 3. The computing device 300 includes a processor 301, a memory 302, a communications interface 303, and a bus 304.

The communications interface 303 is a set of interfaces used by the computing device 300 to communicate with a host, a storage apparatus, and another computing device. For example, the communications interface 303 may include a peripheral component interconnect express (PCIE) interface, a non-volatile memory express (NVMe) interface, a serial attached small computer system interface (SAS), a serial advanced technology attachment (SATA) interface, or another interface for connecting to the host. The computing device 300 receives a data prefetching instruction, a data read instruction, or another instruction from the host using the PCIE interface or another interface, and sends a locally stored target data block to the host. The communications interface 303 may further include a disk controller or another interface for connecting to the storage apparatus, and the computing device 300 accesses the storage apparatus using the disk controller or the other interface. In addition, the communications interface 303 may further include a network interface card (NIC) for connecting to the Ethernet such that a plurality of computing devices can access each other using the Ethernet. The communications interface 303 may be an interface in another form, and is not limited herein.

The memory 302 may include a volatile memory, for example, a random access memory (RAM), or the memory may include a non-volatile memory, for example, a read-only memory (ROM), a flash memory, a hard disk drive (HDD), or an SSD. The memory 302 may further include a combination of the foregoing types of memories. The computing device 300 is configured to prefetch a target data block to the local storage space of the computing device 300, and the prefetched target data block is stored in the memory 302. When the technical solution provided in the present disclosure is implemented by software, program code for implementing a data prefetching method provided in FIG. 4 of the present disclosure may be stored in the memory 302, and executed by the processor 301.

The processor 301 may be a central processing unit (CPU), a hardware chip, or a combination of the CPU and the hardware chip. During running, the processor 301 may perform the following steps by invoking the program code in the memory 302 before a first host starts a VM, receiving a data prefetching instruction from the first host, determining a target data block based on the data prefetching instruction, obtaining identifier information of a target prefetching apparatus from a second prefetching apparatus, determining a target storage location of the target data block based on identifier information of the target data block, obtaining and saving the target data block based on the target storage location of the target data block, and receiving a data read instruction, and sending the target data block to the first host based on the data read instruction.

The processor 301, the memory 302, and the communications interface 303 may be communicatively connected to each other using the bus 304, or may implement communication by other means such as wireless transmission.

The present disclosure further provides a data prefetching method. The prefetching apparatus in FIG. 2 or the computing device 300 in FIG. 3 perform the data prefetching method during running. The following describes the data prefetching method using only a first prefetching apparatus as an example, and for a basic procedure of the data prefetching method, refer to FIG. 4. The method includes the following steps.

Step 401. Before a first host starts a VM, receive a data prefetching instruction from the first host.

The first prefetching apparatus receives the data prefetching instruction delivered by the first host, and the data prefetching instruction is used to indicate start data required by the first host to start the VM on the first host.

Optionally, at an initial running stage of a cluster system, the first prefetching apparatus may register a virtual storage disk with a hypervisor on the first host, to present, to the first host in a form of a virtual storage disk, a storage apparatus that in the cluster system and that is connected southbound. The virtual storage disk may be in a form of a virtual disk such as a virtual NVMe disk, a virtual SAS disk, or a virtual SATA disk, or may be in another form. In addition, a memory of the first prefetching apparatus may store a mapping table. The mapping table is used to record a correspondence between a storage apparatus in the cluster system and a virtual storage disk on a host. The VM and the hypervisor on the first host do not perceive realness of the virtual storage disk, and consider the virtual storage disk as a real physical memory.

The hypervisor is responsible for managing VMs on the host, and therefore can detect start of the VMs. Optionally, the hypervisor on the first host delivers a DSM instruction to the virtual storage disk on the first host before the VM on the first host is started, and the DSM instruction is used to indicate data required for starting the VM on the first host. The DSM instruction delivered to the virtual storage disk is actually received by the first prefetching apparatus.

Step 402. Determine a target data block based on the data prefetching instruction.

The first prefetching apparatus partitions to-be-prefetched boot image data into one or more target data blocks based on the data prefetching instruction. Optionally, the first prefetching apparatus may perform aligned partitioning on the boot image data based on a storage granularity of the cluster system. For example, if the storage granularity of the cluster system is 1 megabytes (MB), and a logical address of the to-be-prefetched boot image data is 2.5 MB to 4.5 MB, the first prefetching apparatus may partition the boot image data into three target data blocks 2.5 MB to 3 MB, 3 MB to 4 MB, and 4 MB to 4.5 MB. It should be noted that if aligned portioning is performed on the boot image data based on the storage granularity, all data in a single obtained target data block is stored in a same storage apparatus, and data in different target data blocks may be stored in different storage apparatuses.

After determining the target data block, the first prefetching apparatus performs all subsequent steps from steps 403 to 406 in this embodiment on each data block.

After determining the target data block, the first prefetching apparatus determines whether data in the target data block is locally stored in the first prefetching apparatus. Optionally, the first prefetching apparatus may search for, based on a globally unique identifier (GUID) of a virtual storage disk corresponding to the target data block, a logical address of the target data block in the virtual storage disk, and the stored mapping table, a storage apparatus in which the target data block is located and a logical address of the target data block in the storage apparatus. Then a local logical address list is searched for the logical address of the target data block in the storage apparatus, to determine whether the target data block is locally stored in the first prefetching apparatus.

If the target data block is locally stored in the first prefetching apparatus, only step 406 needs to be directly performed, without a need to perform a data prefetching operation in steps 403 to 405.

If the target data block is not locally stored in the first prefetching apparatus, the first prefetching apparatus needs to obtain the target data block to the first prefetching apparatus. The following describes, using steps 403 to 405, in detail a method for prefetching the target data block by the first prefetching apparatus.

Step 403. Obtain identifier information of a target prefetching apparatus from a second prefetching apparatus.

If the target data block is not locally stored in the first prefetching apparatus, the first prefetching apparatus needs to obtain the identifier information of the target prefetching apparatus.

As mentioned in step 402, the first prefetching apparatus may find the storage apparatus in which the target data block is located. In this embodiment, only that the target data block is stored in a second storage apparatus in the cluster system is used as an example for description. Similar to a connection manner among the first host, the first prefetching apparatus, and a first storage apparatus, the second storage apparatus is connected southbound to the second prefetching apparatus, and the second prefetching apparatus is connected southbound to a second host. It can be learned that, to access the second storage apparatus, all other prefetching apparatuses in the cluster system need to use the second prefetching apparatus. In the present disclosure, a prefetching apparatus that stores the target data block is referred to as a target prefetching apparatus. It may be understood that, because the first prefetching apparatus does not store the target data block, the target prefetching apparatus does not include the first prefetching apparatus, but can be any prefetching apparatus in the cluster system other than the first prefetching apparatus (including the second prefetching apparatus). Generally, when the target prefetching apparatus accesses the target data block in the second storage apparatus using the second prefetching apparatus, the second prefetching apparatus records the identifier information of the target prefetching apparatus, such as an Internet Protocol (IP) address and a device number. Therefore, the first prefetching apparatus can obtain the identifier information of the target prefetching apparatus from the second prefetching apparatus.

Optionally, to ensure that each prefetching apparatus is not accessed frequently, one access threshold may be set for each prefetching apparatus. Only a prefetching apparatus that stores the target data block and that is accessed by another prefetching apparatus for a quantity of times that is less than the access threshold is considered as a target prefetching apparatus.

Optionally, the first prefetching apparatus may request address information of the target prefetching apparatus from the second prefetching apparatus, and receive an identifier information list returned by the second prefetching apparatus. The identifier information list may record identifier information of one or more target prefetching apparatuses.

It should be noted that in this embodiment, only the second storage apparatus is used to represent a storage apparatus that stores the target data block. In an embodiment, the second storage apparatus and the first storage apparatus may be a same storage apparatus. In this case, the second prefetching apparatus and the first prefetching apparatus are actually a same prefetching apparatus.

Step 404. Determine a target storage location of the target data block based on the identifier information of the target data block.

After obtaining the identifier information of the target data block, the first prefetching apparatus determines the target storage location of the target data block based on the identifier information of the target data block. The target storage location is one of one or more storage locations of the target data block in the cluster system. There are many criteria for selecting the target storage location from the storage locations of the target data block in the cluster system. For example, in the storage locations of the target data block in the cluster system, a location that has a shortest network distance to the first prefetching apparatus may be determined as the target storage location, or a location for which the first prefetching apparatus has a shortest access delay is determined as the target storage location. Alternatively, the target storage location may be determined based on another criterion, and this is not limited herein.

Optionally, if the identifier information list returned by the second prefetching apparatus is empty, it indicates that no prefetching apparatus reads the target data block from the second storage apparatus, and the target data block is stored merely in the second storage apparatus. In this case, the first prefetching apparatus determines the second storage apparatus as the target storage location of the target data block.

Optionally, if the identifier information list returned by the second prefetching apparatus is not empty, it indicates that a target prefetching apparatus reads the target data block from the second storage apparatus. The target data block is stored not only in the second storage apparatus, but also in the target prefetching apparatus. In this case, the first prefetching apparatus may determine and obtain the target storage location of the target data block based on identifier information of the target prefetching apparatus that is recorded in the identifier information list. For details, refer to a determining method in (1) to (3).

(1) The first prefetching apparatus separately determines delays of accessing all target prefetching apparatuses, and determines a shortest delay t1 in the delays of accessing all the target prefetching apparatuses, and a target prefetching apparatus corresponding to t1.

(2) The first prefetching apparatus determines a delay t2 of accessing the second storage apparatus using the second prefetching apparatus.

(3) If t1 is less than t2, the first prefetching apparatus determines the target prefetching apparatus corresponding to t1 as the target storage location of the target data block, if t1 is greater than t2, the first prefetching apparatus determines the second storage apparatus as the target storage location of the target data block, or if t1 is equal to t2, the first prefetching apparatus may determine the target prefetching apparatus corresponding to t1 as the target storage location of the target data block, or may determine the second storage apparatus as the target storage location of the target data block.

Alternatively, the first prefetching apparatus may determine the target storage location of the target data block using another method, and this is not limited herein.

Step 405. Obtain and save the target data block based on the target storage location of the target data block.

After determining an obtaining path of the target data block, the first prefetching apparatus prefetches the target data block to the first prefetching apparatus based on the obtaining path.

Optionally, after step 405, the second prefetching apparatus may record identifier information of the first prefetching apparatus, indicating that the first prefetching apparatus stores the target data block.

Based on the data prefetching method provided in the present disclosure, the prefetching apparatus is added between the host and the storage apparatus, to prefetch, to the prefetching apparatus based on the data prefetching instruction of the host, the boot image data required by the host during start such that the host can use the boot image data. In this method, the boot image data originally stored in a cache of the host is stored in the prefetching apparatus outside the host, and when the VM on the host is being started, the boot image data is directly obtained from the prefetching apparatus. Compared with the traditional technology in which the boot image data is directly read from the storage apparatus, in this embodiment, repeated data needs to be written into the prefetching apparatus only once. This reduces data read and write times and bandwidth occupation. Compared with the traditional technology in which the boot image data is stored in the cache of the host, in the method provided in the present disclosure, the boot image data does not occupy much of the cache of the host. Therefore, a host cache hit rate is not low, and a cache occupation rate is not high. This accelerates a host service process, and improves host service performance.

Optionally, in the method provided in the present disclosure, after the boot image data is prefetched, step 406 may be further performed.

Step 406. Receive a data read instruction, and send the target data block to the first host according to the data read instruction.

The target data block is prefetched to the prefetching apparatus after the first prefetching apparatus performs step 401 to 405. When the VM on the first host is being started, the first host delivers the data read instruction to the first prefetching apparatus, to instruct to read the target data block. The first prefetching apparatus receives the data read instruction, and sends the locally stored target data block to the first host based on the data read instruction.

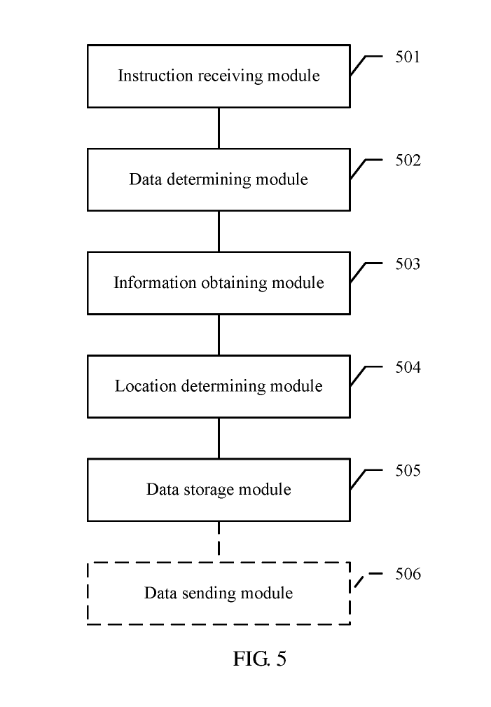

In an embodiment shown in FIG. 5, the data prefetching method provided in the present disclosure is described. The following describes a prefetching apparatus for implementing the method, and for a basic structure of the prefetching apparatus, refer to FIG. 5. The prefetching apparatus includes an instruction receiving module 501 configured to perform an operation in step 401 in the embodiment shown in FIG. 4, a data determining module 502 configured to perform an operation in step 402 in the embodiment shown in FIG. 4, an information obtaining module 503 configured to perform an operation in step 403 in the embodiment shown in FIG. 4, a location determining module 504 configured to perform an operation in step 404 in the embodiment shown in FIG. 4, and a data storage module 505 configured to perform an operation in step 405 in the embodiment shown in FIG. 4.

For related description of the apparatus shown in FIG. 5, correspondingly refer to related description and effects in the method embodiment shown in FIG. 4 for understanding, and details are not described herein.

Optionally, the instruction receiving module 501 may further receive a data read instruction delivered by a first host, and the data read instruction is used to instruct to read a target data block. The prefetching apparatus shown in FIG. 5 may further include a data sending module 506 configured to send the target data block to the first host after the instruction receiving module 501 receives the data read instruction.

The prefetching apparatus provided in FIG. 5 is located between a host and a storage apparatus. The instruction receiving module 501 receives a data prefetching instruction from the host, the data determining module 502 determines the target data block based on the data prefetching instruction of the host, the information obtaining module 503 obtains identifier information of one or more target prefetching apparatuses that store the target data block, the location determining module 504 determines a target storage location of the target data block, and the data storage module 505 prefetches the target data block from the target storage location to the prefetching apparatus such that the host can use the target data block. In this processing, boot image data originally stored in a cache of the host is stored in the prefetching apparatus outside the host, and when a VM on the host is being started, the boot image data is directly obtained from the prefetching apparatus. Compared with the traditional technology in which the boot image data is directly read from the storage apparatus, in this embodiment, repeated data needs to be written into the prefetching apparatus only once. This reduces data read and write times and bandwidth occupation. Compared with the other approaches in which the boot image data is stored in the cache of the host, in the method provided in the present disclosure, the boot image data does not occupy much of the cache of the host. Therefore, a host cache hit rate is not low, and a cache occupation rate is not high. This accelerates a host service process, and improves host service performance.

In the several embodiments provided in this disclosure, it should be understood that the disclosed system, apparatus, and method may be implemented in other manners. For example, the described apparatus embodiment is merely an example. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

In addition, functional modules in the embodiments of the present disclosure may be integrated into one processing module, or each of the modules may exist alone physically, or two or more modules are integrated into one module. The integrated module may be implemented in a form of hardware, or may be implemented in a form of a software functional module.

When the integrated module is implemented in the form of a software functional module and sold or used as an independent product, the integrated unit may be stored in a computer-readable storage medium. Based on such an understanding, the technical solutions of the present disclosure essentially, or the part contributing to the other approaches, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a ROM, a RAM, a magnetic disk, or an optical disc.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A data prefetching method performed by a first prefetching apparatus, comprising:
receiving a data prefetching instruction from a first host, the data prefetching instruction indicating that boot image data is required by the first host;
determining a target data block based on the data prefetching instruction, the target data block being a portion of the boot image data;
obtaining identification of a target prefetching apparatus from a second prefetching apparatus;
determining a target storage location of the target data block based on the identification; and
obtaining the target data block based on the target storage location.

2. The data prefetching method of claim 1, wherein obtaining the identification of the target prefetching apparatus comprises:
requesting the identification of the target prefetching apparatus from the second prefetching apparatus; and
receiving an identification list of the target prefetching apparatus from the second prefetching apparatus, the identification list comprising at least one identification of the target prefetching apparatus.

3. The data prefetching method of claim 2, wherein determining the target storage location comprises setting a target storage apparatus as the target storage location when the identification list of the target prefetching apparatus is empty.

4. The data prefetching method of claim 2, wherein determining the target storage location comprises:
determining, based on identification of each target prefetching apparatus, a shortest delay in delays of accessing all target prefetching apparatuses and a target prefetching apparatus corresponding to the shortest delay when the identification list of the target prefetching apparatus is not empty;
setting the target prefetching apparatus corresponding to the shortest delay as the target storage location of the target data block when the shortest delay is less than a delay of accessing a target storage apparatus using the second prefetching apparatus; and
setting the target storage apparatus as the target storage location of the target data block when the shortest delay is greater than the delay of accessing the target storage apparatus using the second prefetching apparatus.

5. The data prefetching method of claim 1, wherein determining the target data block comprises partitioning the boot image data based on the data prefetching instruction to obtain one or more target data blocks.

6. The data prefetching method of claim 1, wherein receiving the data prefetching instruction comprises:
creating a virtual storage disk on the first host; and
obtaining the data prefetching instruction from the virtual storage disk after the first host delivers the data prefetching instruction to the virtual storage disk.

7. The data prefetching method of claim 1, further comprising:
receiving a data read instruction instructing to read the target data block from the first host when the first host starts a virtual machine on the first host; and
sending, based on the data read instruction, the target data block stored in the first prefetching apparatus to the first host.

8. A first computer device, comprising:
a memory comprising a plurality of instructions; and
a processor coupled to the memory, the instructions causing the processor to be configured to:
receive a data prefetching instruction from a first host, the data prefetching instruction indicating that boot image data is required by the first host;
determine a target data block based on the data prefetching instruction, the target data block being a portion of the boot image data;
obtain identification of a target prefetching apparatus from a second prefetching apparatus;
determine a target storage location of the target data block based on the identification; and
obtain the target data block based on the target storage location.

9. The first computer device of claim 8, wherein when obtaining the identification of the target prefetching apparatus, the instructions further cause the processor to be configured to:
request the identification of the target prefetching apparatus from the second prefetching apparatus; and
receive an identification list of the target prefetching apparatus from the second prefetching apparatus, the identification list comprising at least one identification of the target prefetching apparatus.

10. The first computer device of claim 9, wherein when determining the target storage location of the target data block, the instructions further cause the processor to be configured to set a target storage apparatus as the target storage location when the identification list of the target prefetching apparatus is empty.

11. The first computer device according to claim 9, wherein when determining the target storage location of the target data block, the instructions further cause the processor to be configured to:
determine, based on identification of each target prefetching apparatus, a shortest delay in delays of accessing all target prefetching apparatuses and a target prefetching apparatus corresponding to the shortest delay when the identification list of the target prefetching apparatus is not empty;
set the target prefetching apparatus corresponding to the shortest delay as the target storage location of the target data block when the shortest delay is less than a delay of accessing a target storage apparatus using the second prefetching apparatus; and
set the target storage apparatus as the target storage location of the target data block when the shortest delay is greater than the delay of accessing the target storage apparatus using the second prefetching apparatus.

12. The first computer device of claim 8, wherein when determining the target data block, the instructions further cause the processor to be configured to partition the boot image data based on the data prefetching instruction to obtain one or more target data blocks.

13. The first computer device of claim 8, wherein when receiving the data prefetching instruction, the instructions further cause the processor to be configured to:
create a virtual storage disk on the first host; and
obtain the data prefetching instruction from the virtual storage disk after the first host delivers the data prefetching instruction to the virtual storage disk.

14. The first computer device of claim 8, wherein the instructions further cause the processor to be configured to:
receive a data read instruction instructing to read the target data block from the first host when the first host starts a virtual machine on the first host; and
send, based on the data read instruction, the target data block stored in the first computer device to the first host.

15. A computer-readable storage medium comprising instructions which, when executed by a computer, cause the computer to:
receive a data prefetching instruction from a first host, the data prefetching instruction indicating that boot image data is required by the first host;
determine a target data block based on the data prefetching instruction, the target data block being a portion of the boot image data;
obtain identification of a target prefetching apparatus from a second prefetching apparatus;
determine a target storage location of the target data block based on the identification; and
obtain the target data block based on the target storage location.
